(19) United States
(12) Patent Application Publication
(10) Pub. No.: US 2012/0236131 A1
(43) Pub. Date: Sep. 20, 2012

(54) DISPLAY DEVICE, DISPLAY SYSTEM, AND METHOD FOR CONTROLLING DISPLAY DEVICE

(75) Inventor: Masaki Kishimoto, Beppu-shi (JP)

(73) Assignee: Seiko Epson Corporation, Tokyo (JP)

(21) Appl. No.: 13/416,159

(22) Filed: Mar. 9, 2012

(30) Foreign Application Priority Data
Mar. 16, 2011 (JP) 2011-057681

(51) Int. Cl. H04N 13/04

(52) U.S. Cl. 348/54; 348/E13.026

(57) ABSTRACT

A display device includes: a display unit which displays a parallax image on a display surface; a viewing position deriving unit which obtains a viewing position suitable for stereoscopic vision on the basis of the display surface; and a display control unit which causes the display unit to perform display for showing the viewing position obtained by the viewing position deriving unit.

The entire disclosure of Japanese Patent Application No. 2011-057681 filed Mar. 16, 2011 is expressly incorporated by reference herein.

### BACKGROUND

1. Technical Field

The present invention relates to a display device which displays an image, a display system, and a method for controlling a display device.

2. Related Art

In the related art, a system has been known in which a display device which displays a stereoscopic image (3D image) is combined with an eyeglass-type device which enables the stereoscopic image to be visually recognized corresponding to the display device (for example, refer to JP-A-2010-98479). This type of system displays an image for the left eye and an image for the right eye which are displayed by the display device, and causes the image for the left eye to reach only the left eye of a viewer and the image for the right eye to reach only the right eye with the eyeglass-type device. Moreover, the device disclosed in JP-A-2010-98479 optimizes the amount of parallax according to a projection distance to a screen.

In the case where a viewer views a stereoscopic image, when the position of the viewer is greatly deviated from the front of a display surface or too close to the display surface, a large difference in vision between a left-eye image and a right-eye image is generated, and therefore, the viewer sometimes has a feeling of discomfort, what is called 3D sickness. For preventing such a feeling of discomfort, it is only necessary for the viewer to view the stereoscopic image from a proper position. However, the position of the viewer is sometimes limited, such as the case where there are a plurality of viewers or the case where a thing is placed close to the display surface. In this case, it is hard to previously determine whether or not the position of the viewer is proper for viewing the stereoscopic image, and it is difficult to prevent such a situation that the viewer has a feeling of discomfort.

### SUMMARY

An advantage of some aspects of the invention is to enable a viewer to determine a position suitable for viewing a stereoscopic image.

An aspect of the invention is directed to a display device including: a display unit which displays a parallax image on a display surface; a viewing position deriving unit which obtains a viewing position suitable for stereoscopic vision on the basis of the display surface; and a display control unit which causes the display unit to perform display for showing the viewing position obtained by the viewing position deriving unit.

According to the aspect of the invention, since the viewing position suitable for stereoscopic vision is shown by display, it is possible to reliably inform a viewer of the position suitable for viewing. Thus, the viewer can properly determine from which position the viewer should view.

Moreover, according to the aspect of the invention, the viewing position suitable for stereoscopic vision can be precisely derived according the specification or state of the display surface, and therefore, the position can be precisely shown to a viewer.

Moreover, according to the aspect of the invention, the viewing position suitable for stereoscopic vision can be shown to a viewer in such a manner that is easily understood intuitively, and the viewer can therefore easily determine from which position the viewer should view.

Moreover, according to the aspect of the invention, display reflecting that whether or not the position of a viewer is deviated from a preferable viewing position can be performed, and it can therefore be shown whether or not the current position of the viewer is a position suitable for viewing a stereoscopic image.

Moreover, according to the aspect of the invention, when a parallax image is viewed with a stereoscopic device, it is possible to prevent a feeling of discomfort or the like due to an improper viewing position.

Moreover, according to the aspect of the invention, it is possible to show a viewer a proper viewing position when the viewer views a stereoscopic image using a projector which projects an image on a projection surface. Thus, even when it is hard for the viewer to determine the proper viewing position by him/herself because of characteristics of the projector such as, for example, the large projection surface, it is possible to inform the viewer of the position suitable for viewing. Thus, the viewer can properly determine from which position the viewer should view.

Another aspect of the invention is directed to a display system including: a display device including a display unit which displays a parallax image on a display surface; and a stereoscopic device for observing the parallax image, wherein the display device further includes a viewing position deriving unit which obtains a viewing position suitable for stereoscopic vision through the stereoscopic device on the basis of the display surface, and a display control unit which causes the display unit to perform display for showing the viewing position obtained by the viewing position deriving unit.

According to the aspect of the invention, since the viewing position suitable for stereoscopic vision is shown by display, it is possible to reliably inform a viewer of the position suitable for viewing. Thus, the viewer can properly determine from which position the viewer should view.

Still another aspect of the invention is directed to a method for controlling a display device, including: displaying a parallax image on a display surface; obtaining a viewing position suitable for stereoscopic vision on the basis of the display surface; and performing display for showing the obtained viewing position.

According to the aspect of the invention, since the viewing position suitable for stereoscopic vision is shown by display, it is possible to reliably inform a viewer of the position suitable for viewing. Thus, the viewer can properly determine from which position the viewer should view.

In any of the aspects of the invention, the viewing position is not limited to a position obtained as a point, but includes a range including a number of points. That is, any of the aspects of the invention includes obtaining, as the viewing position, a specific position suitable for stereoscopic vision as well as obtaining a range suitable for stereoscopic vision.

According to the aspect of the invention, since the viewing position suitable for stereoscopic vision is shown by display, it is possible to reliably inform a viewer of the position suitable for viewing. Thus, the viewer can properly determine from which position the viewer should view.

### BRIEF DESCRIPTION OF THE DRAWINGS

The invention will be described with reference to the accompanying drawings, wherein like numbers reference like elements.

FIG. 1 shows a schematic configuration of a display system according to an embodiment of the invention.

FIG. 2 is a block diagram showing a functional configuration of a stereoscopic device.

FIG. 3 is a block diagram showing a functional configuration of a projector.

FIG. 4 is an explanatory view of a method for deriving a range of viewing position.

FIGS. 5A and 5B each show an example of a guide image displayed by the projector, in which FIG. 5A shows an example of a guide image displayed when the stereoscopic device is located within a range of viewing position and FIG. 5B shows an example of a guide image displayed when the stereoscopic device is located outside the range of viewing position.

FIG. 6 is a flowchart showing operation of the projector.

### DESCRIPTION OF EXEMPLARY EMBODIMENTS

Hereinafter, an embodiment of the invention will be described with reference to the drawings.

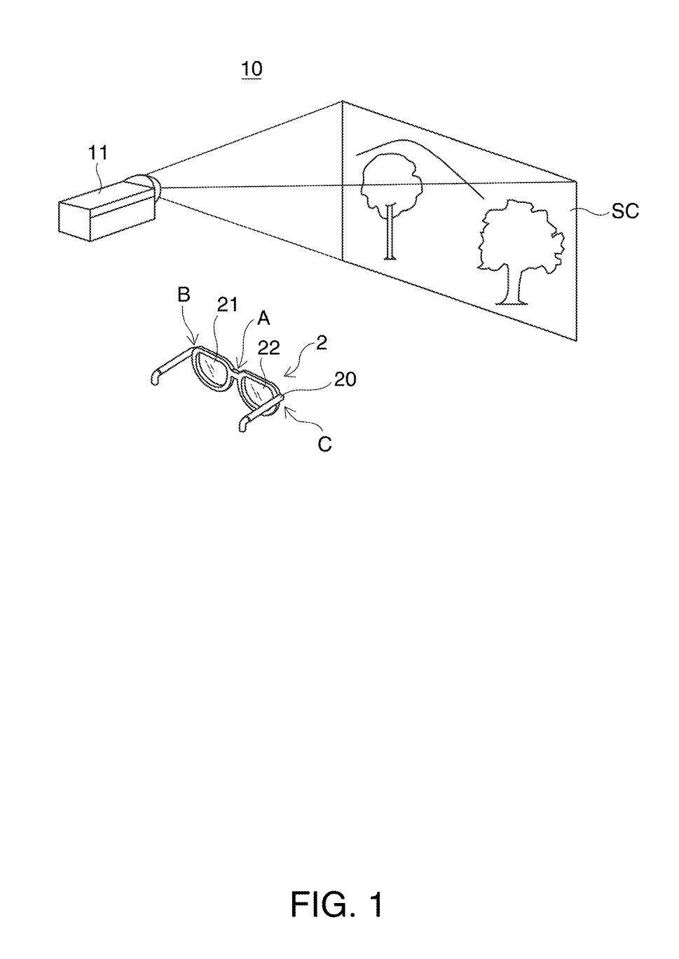

FIG. 1 shows a schematic configuration of a display system 10 to which the invention is applied.

The display system 10 includes a projector 11 as a display device which projects a still image or a moving image onto a screen SC and a stereoscopic device 2 which is worn by a viewer who views the image projected by the projector 11. The projector 11 is fixed to, for example, a floor, a pedestal installed to a floor, or a ceiling. The screen SC stands substantially upright, for example, and its screen surface has a rectangular shape. The projector 11 focuses a parallax image which can be viewed stereoscopically on the screen SC, and a viewer wears the stereoscopic device 2 to view the parallax image on the screen SC, whereby stereoscopic vision is possible.

The stereoscopic device 2 has an eyeglass-type frame 20 and is mounted on a head of a viewer similarly to eyeglasses. The frame 20 is provided with a left-eye shutter 21 (left-eye transmitting portion) which opens and closes the left eye's view of a viewer and a right-eye shutter 22 (right-eye transmitting portion) which opens and closes the right eye's view of the viewer. FIG. 1 illustrates the configuration of the display system 10 using one stereoscopic device 2. However, the number of the stereoscopic devices 2 which can be used in combination with the projector 11 is not limited. In the embodiment, the case of using one or a plurality of stereoscopic devices 2 will be described.

The parallax image projected by the projector 11 includes a left-eye image and a right-eye image with parallax. The projector 11 alternately focuses a left-eye image and a right-eye image on the screen SC, and the frame 20 alternately opens and closes the left-eye shutter 21 as the left-eye transmitting portion and the right-eye shutter 22 as the right-eye transmitting portion in synchronization with the switching between the left-eye image and the right-eye image of the projector 11. With this configuration, since a viewer visually recognizes the left-eye image with the left eye and visually recognizes the right-eye image with the right eye, the viewer can stereoscopically view the parallax image projected by the projector 11.

The display system 10 synchronizes, by transmitting a synchronizing signal wirelessly, a timing at which the stereoscopic device 2 opens and closes the left-eye shutter 21 and the right-eye shutter 22 with a timing at which the projector 11 switches display between a left-eye image and a right-eye image on the screen SC.

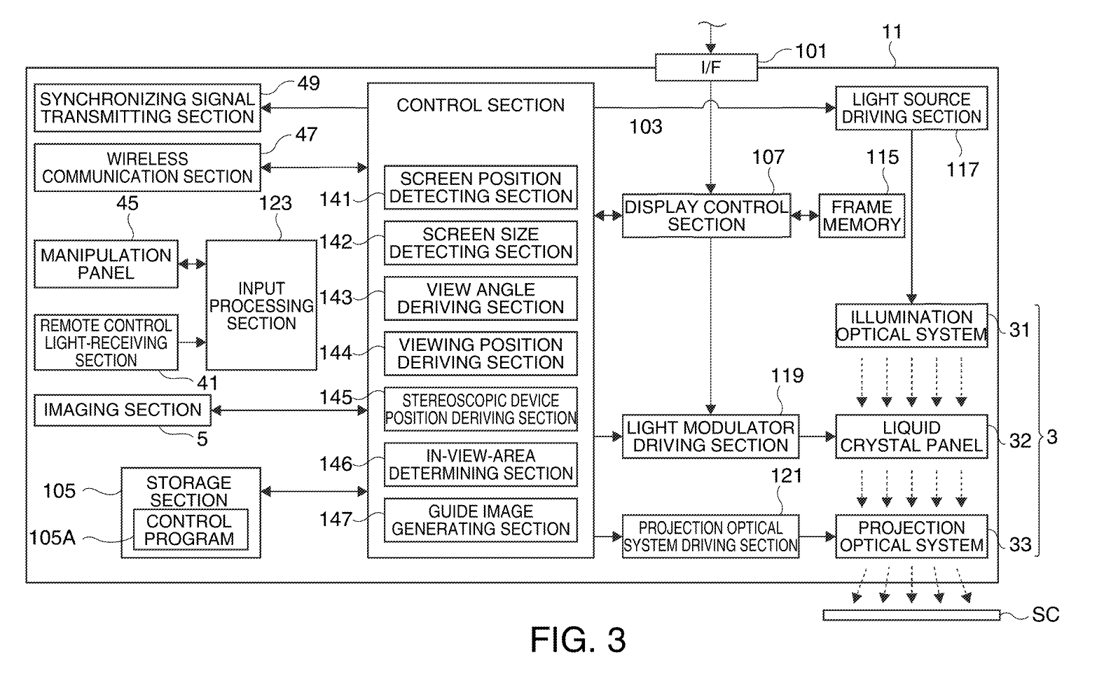

The synchronizing signal is a signal representing the timing at which the stereoscopic device 2 opens and closes the left-eye shutter 21 and the right-eye shutter 22, and the projector 11 transmits the synchronizing signal to the stereoscopic device 2 with the function of a synchronizing signal transmitting section 49 (FIG. 3) which will be described later. The synchronizing signal is transmitted as, for example, an infrared signal. Therefore, even when the plurality of stereoscopic devices 2 are provided, all the stereoscopic devices 2 each receive the synchronizing signal to switch the shutters when the projector 11 transmits the synchronizing signal, whereby stereoscopic vision is possible.

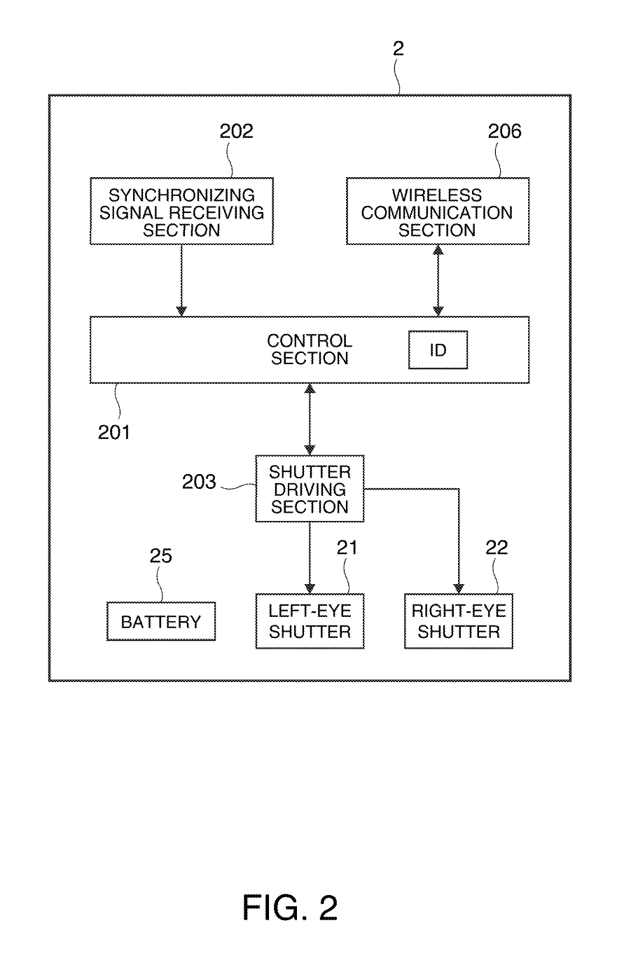

FIG. 2 is a block diagram showing a functional configuration of the stereoscopic device 2.

The stereoscopic device 2 includes a control section 201 which controls each section of the stereoscopic device 2, a synchronizing signal receiving section 202 which receives a synchronizing signal transmitted from the projector 11, a shutter driving section 203 (shutter driving unit) which opens and closes the left-eye shutter 21 and the right-eye shutter 22 under the control of the control section 201, and a wireless communication section 206 which transmits and receives a wireless signal to and from the projector 11.

The synchronizing signal receiving section 202 receives a synchronizing signal transmitted from the projector 11 and outputs the synchronizing signal to the control section 201. The shutter driving section 203 opens and closes the left-eye shutter 21 and the right-eye shutter 22 in synchronization with the synchronizing signal received by the synchronizing signal receiving section 202. The left-eye shutter 21 and the right-eye shutter 22 are each composed of, for example, a liquid crystal shutter. While the left-eye shutter 21 is opened, a viewer can visually recognize an image on the screen SC with the left eye, and while the right-eye shutter 22 is opened, the viewer can visually recognize an image on the screen SC with the right eye. The timing of opening and closing of the left-eye shutter 21 and the right-eye shutter 22 is set to the time of displaying a left-eye image and a right-eye image on the screen SC, whereby the left-eye image and the right-eye image can be transmitted individually.

The stereoscopic device 2 includes a battery 25 (power source) and supplies power from the battery 25 to the sections including the control section 201 and the shutter driving section 203.

The wireless communication section 206 is so configured that near field communication such as Bluetooth (registered trademark) or wireless LAN can be established. The wireless communication section 206 receives a wireless signal transmitted by a later-described wireless communication section 47 (FIG. 3) of the projector 11, while transmitting a wireless signal to the projector 11 under the control of the control section 201. In this case as shown in FIG. 2, the control section 201 of the stereoscopic device 2 stores an ID as unique identification information which is previously set in a built-in storage section. The control section 201 transmits the ID by including the ID in operation information to be transmitted by the wireless communication section 206.

When a power switch is turned on, the stereoscopic device 2 starts operating under the control of the control section 201, receives a synchronizing signal through the synchronizing signal receiving section 202, and opens and closes the left-eye shutter 21 and the right-eye shutter 22 with the shutter driving section 203 in synchronization with the synchronizing signal. Moreover, the stereoscopic device 2 transmits and receives a wireless signal to and from the projector 11 via the wireless communication section 206 and transmits, as necessary, a signal to which the ID stored by the control section 201 is appended.

FIG. 3 is a block diagram showing a functional configuration of the projector 11.

The projector 11 is connected to an external image supply device (not illustrated), such as a personal computer or various kinds of image players, via an I/F (interface) section 101 and projects an input image input from any of these image supply devices onto the screen SC. For example, the I/F section 101 includes a USB interface, a wired or wireless LAN interface, a VGA terminal to which an analog video signal is input, a DVI (Digital Visual Interface) to which a digital video signal is input, an S-video terminal to which a composite video signal such as NTSC, PAL, or SECAM is input, an RCA terminal to which a composite video signal is input, a D terminal to which a component video signal is input, and an HDMI connector conforming to HDMI (registered trademark) standard. The I/F section 101 may include an interface circuit which inputs and outputs a signal via the terminals or connector described above.

Examples of the image supply device include video players, DVD players, TV tuner devices, set-top boxes of CATV, image output devices such as video game devices, and personal computers. In the embodiment, a description will be made on the assumption that digital image data is input from the image supply device to the I/F section 101. The digital image data includes, together with image data itself, information on the image format of the digital image data. For example, when input image data is stereoscopic image data, various kinds of pieces of information, including data representing a stereoscopic video format (side-by-side format, top-and-bottom format, frame sequential format, etc.), a frame rate, and a resolution, are included.

The projector 11 is basically composed of a projection section 3 (display unit) which forms an optical image and an image processing system which electrically processes an image signal input to the projection section 3. The projection section 3 is composed of an illumination optical system 31, a liquid crystal panel 32 as a light modulator, and a projection optical system 33. The illumination optical system 31 includes a light source which is composed of a xenon lamp, an extra-high-pressure mercury lamp, an LED (Light Emitting Diode), or the like. Moreover, the illumination optical system 31 may include a reflector and an auxiliary reflector which introduce light emitted from the light source to the liquid crystal panel 32, and may include a lens group (not illustrated) for enhancing optical characteristics of projected light, a polarizer, and a dimming element which decreases the amount of the light emitted by the light source on the way to the liquid crystal panel 32.

The liquid crystal panel 32 as a modulation unit forms an image on a panel surface in response to a signal from the image processing system which will be described later. The liquid crystal panel 32 is composed of three liquid crystal panels corresponding to three primary colors of RGB for performing color projection. Therefore, light from the illumination optical system 31 is separated into three colored lights of RGB, and each of the colored lights is incident on the corresponding liquid crystal panel. The colored lights modulated by transmitting through the respective liquid crystal panels are combined by a combining optical system such as a cross dichroic prism and then emitted to the projection optical system 33.

The projection optical system 33 as a projection unit includes a zoom lens which enlarges and shrinks an image to be projected and adjusts the focus, a zoom-adjusting motor which adjusts the degree of zoom, and a focus-adjusting motor which adjusts the focus. The projection optical system 33 projects incident light modulated by the liquid crystal panel 32 onto the screen SC using the zoom lens to focus an image on the screen.

To the projection section 3, a projection optical system driving section 121 and a light source driving section 117 are connected. The projection optical system driving section 121 drives each of the motors included in the projection optical system 33 under the control of a control section 103. The light source driving section 117 drives the light source of the illumination optical system 31 under the control of the control section 103.

The image processing system is mainly composed of the control section 103 which integrally controls the entire projector 11. The image processing system includes a storage section 105, an input processing section 123, a display control section 107, and a light modulator driving section 119. The storage section 105 stores data to be processed by the control section 103 or control programs 105A to be executed by the control section 103. The input processing section 123 detects manipulations via a manipulation panel 45 and a remote control light-receiving section 41. The display control section 107 processes input image data. The light modulator driving section 119 drives, based on an image signal output from the display control section 107, the liquid crystal panel 32 to perform drawing.

The control section 103 reads and executes the control program stored in the storage section 105 to thereby control each of the sections of the projector 11. The control section 103 detects, based on a manipulation signal input from the input processing section 123, the content of a manipulation performed by a user, and controls, according to the manipulation, the display control section 107, the light modulator driving section 119, the projection optical system driving section 121, and the light source driving section 117 to project an image onto the screen SC.

In a main body of the projector 11, the manipulation panel 45 including various kinds of switches and indicator lights with which a user performs a manipulation is arranged. The manipulation panel 45 is connected to the input processing section 123, which appropriately turns on or turns off, under the control of the control section 103, the indicator light of the manipulation panel 45 according to the operational state or setting state of the projector 11. When the switch of the manipulation panel 45 is manipulated, a manipulation signal corresponding to the manipulated switch is output from the input processing section 123 to the control section 103.

Moreover, the projector 11 includes the remote control light-receiving section 41 which receives an infrared signal transmitted from a remote control (not illustrated) used by a user. The remote control light-receiving section 41 decodes the infrared signal received from the remote control, generates a manipulation signal representing the content of a manipulation through the remote control, and outputs the manipulation signal to the control section 103.

The display control section 107 is connected to the external image supply device (not illustrated). The display control section 107 generates, under the control of the control section 103, a display signal based on an input image signal input from the image supply device via the I/F section 101 and outputs the display signal to the light modulator driving section 119.

That is, the display control section 107 acquires image data input from the I/F section 101 to determine whether the input image data is 2D (planar) image data or 3D (stereoscopic) image data. If the input image data is stereoscopic image data, the display control section 107 determines the stereoscopic video format. Then, the display control section 107 loads an input image into a frame memory 115 frame by frame. In this case, as for input image data determined as stereoscopic image data, the display control section 107 extracts, according to the stereoscopic video format, each of a left-eye frame (left-eye image) and a right-eye frame (right-eye image) to load them into the frame memory 115. Then, when the resolution of the input image data is different from the display resolution of the liquid crystal panel 32, the display control section 107 performs a resolution converting process, and when it is instructed through a manipulation of the remote control (not illustrated) or the manipulation panel 45 to perform zooming, the display control section 107 performs an enlarging/shrinking process, thereby drawing a display frame after being processed into the frame memory 115.

The display control section 107 outputs, as a display signal, the image loaded into the frame memory 115 frame by frame to the light modulator driving section 119. The liquid crystal panel 32 is driven at, for example, 120 frames per second or 240 frames per second. When a stereoscopic image is displayed, a left-eye frame and a right-eye frame are alternately drawn by the light modulator driving section 119 each at 60 frames per second.

The projector 11 includes the synchronizing signal transmitting section 49 which transmits the synchronizing signal described above for causing the stereoscopic device 2 to operate in synchronization with the switching between a left-eye frame and a right-eye frame drawn on the liquid crystal panel 32. The synchronizing signal is a signal for synchronizing the stereoscopic device 2 with the timing of switching between a left-eye frame and a right-eye frame drawn on the liquid crystal panel 32. However, the timing of opening and closing of the left-eye shutter 21 and the right-eye shutter 22 does not always coincide closely with the timing of drawing the left-eye and right-eye frames on the liquid crystal panel 32. Since an image is drawn on the liquid crystal panel 32 line by line, it takes time from the start of drawing on the liquid crystal panel 32 until one frame is drawn for all the lines. In the middle of this drawing, portions of a frame which was drawn before and portions of a frame which is newly drawn coexist. When the left-eye shutter 21 or the right-eye shutter 22 is opened in such a state that a left-eye frame and a right-eye frame coexist, a phenomenon, so-called crosstalk, is caused. Accordingly, in an ideal example of the synchronizing signal generated by the control section 103, the signal causes the left-eye shutter 21 to open during the time between the completion of drawing a left-eye frame and the start of drawing a right-eye frame, while causing the right-eye shutter 22 to open during the time between the completion of drawing of a right-eye frame and the start of drawing a left-eye frame. Actually, the left-eye shutter 21 and the right-eye shutter 22 are opened and closed according to the drawing speed or frame rate with respect to the liquid crystal panel 32 at a timing adjusted so as not to provide a viewer with a feeling of strangeness caused by crosstalk. The control section 103 generates the synchronizing signal adjusted in such a manner and causes the synchronizing signal transmitting section 49 to transmit the synchronizing signal to the stereoscopic device 2.

The synchronizing signal transmitting section 49 includes, for example, an infrared LED and an LED driving circuit and radiates an infrared signal which is switched between high and low at the timing of generating the infrared signal by the control section 103. For example, in an outer surface of the main body of the projector 11 shown in FIG. 1, a transmitting window of the synchronizing signal transmitting section 49 is disposed toward the side of a viewer wearing the stereoscopic device 2.

The projector 11 includes the wireless communication section 47 which transmits and receives a wireless signal to and from the wireless communication section 206 (FIG. 2) included in the stereoscopic device 2. The wireless communication section 47 transmits a wireless signal to the stereoscopic device 2 under the control of the control section 103 and receives a wireless signal transmitted by the stereoscopic device 2. Moreover, when receiving a wireless signal from the stereoscopic device 2, the wireless communication section 47 measures the receiving intensity, delay time, and the like, and outputs the measured values and the ID of the control section 201 included in the received wireless signal to the control section 103.

FIG. 3 illustrates the projector 11 into which one wireless communication section 47 is incorporated. Actually, however, the projector 11 may have a configuration in which a plurality of wireless communication sections 47 disposed outside the main body of the projector 11 are connected to the control section 103 via a cable or the like. In this case, each of the wireless communication sections 47 outputs the ID and the measured value of the receiving intensity or delay time of the signal received from the stereoscopic device 2 to the control section 103.

Moreover, the projector 11 includes an imaging section 5 which captures the screen SC. The imaging section 5 is disposed toward the same direction as that in which the projection optical system 33 projects an image onto the screen SC. The imaging section 5 captures the screen SC under the control of the control section 103 and outputs captured image data to the control section 103.

The control section 103 executes the control programs 105A stored by the storage section 105 to thereby realize the functions of a screen position detecting section 141, a screen size detecting section 142, a view angle deriving section 143, a viewing position deriving section 144, a stereoscopic device position deriving section 145, an in-view-area determining section 146, and a guide image generating section 147.

The screen position detecting section 141 performs, based on the adjusted state (adjusted value) of zoom and focus in the projection optical system 33, a process for obtaining a projection distance from the projector 11 to the screen SC. The screen size detecting section 142 obtains the projection size of an image on the screen SC based on the captured image data of the imaging section 5, the adjusted state of zoom and focus in the projection optical system 33, and the projection distance obtained by the screen position detecting section 141. The size obtained in this case is the size of the image actually projected onto the screen SC.

The screen size detecting section 142 as a projection size detecting unit may cause, prior to a process for calculating the image size, the display control section 107 to project an image for size detection which is previously stored in the storage section 105 onto the screen SC, and cause the imaging section 5 to capture the image during its projection. In this case, since the captured image data captured by the imaging section 5 is an image suitable for detecting the size, the projection size can be obtained easily and precisely based on the captured image data. Examples of the image for size detection include, for example, a rectangular image in which grid lines are vertically and horizontally drawn entirely and a rectangular image in which dots are arranged in a matrix form at regular intervals.

The view angle deriving section 143 derives the value of a view angle representing a viewable range of an image projected onto the screen SC. The view angle is determined depending on the specification and characteristics of a display device. When a projector is used as a display device like the embodiment, the characteristics of a screen also affect the view angle. The view angle deriving section 143 derives the view angle in consideration of the characteristics of the screen SC as well as the specification and characteristics of the projector 11. Specifically, for example, the view angle deriving section 143 obtains, from information of view angles previously stored in the storage section 105, information matched to the model of the projector 11 and the model of the screen SC.

The viewing position deriving section 144 as a viewing position deriving unit obtains a viewing position based on the projection image size detected by the screen size detecting section 142 and the view angle obtained by the view angle deriving section 143. The viewing position is a position where a viewer can view a stereoscopic image when viewing a parallax image on the screen SC with the stereoscopic device 2, or a position where the viewer can favorably view the stereoscopic image. It can be said that the position is suitable for viewing a stereoscopic image. For example, when a viewer is at a position greatly deviated laterally from the front of the screen SC, or at a position close to the screen SC, a difference in vision between a left-eye image and a right-eye image is increased. Especially when a parallax image is viewed from the side of the screen SC, one of a left-eye image and a right-eye image cannot be visually recognized clearly because of the deviation from the view angle. In such a case, a difference other than original parallax is generated between a left-eye image and a right-eye image. Therefore, normal stereoscopic vision cannot be established, which induces a feeling of discomfort, so-called 3D sickness, and causes fatigued eyes. To put it another way, it can be said that the viewing position derived by the viewing position deriving section 144 is a position where a viewer can visually recognize clearly both a left-eye image and a right-eye image and an extreme difference other than original parallax is not generated in vision between a left-eye image and a right-eye image.

The viewing position derived by the viewing position deriving section 144 is not limited to one point, but also can be derived as a range including a number of points. It is rare that the position suitable for viewing a stereoscopic image is only one point. In most cases, as long as the position of the stereoscopic device 2 with respect to the screen SC is within a specific range, a stereoscopic image can be visually recognized without causing the 3D sickness or fatigued eyes. Thus, the viewing position deriving section 144 of the embodiment obtains a range which can be said as being suitable for viewing a stereoscopic image as long as the stereoscopic device 2 is within the range. It is also possible to obtain one or a plurality of points most suitable for viewing a stereoscopic image with the viewing position deriving section 144.

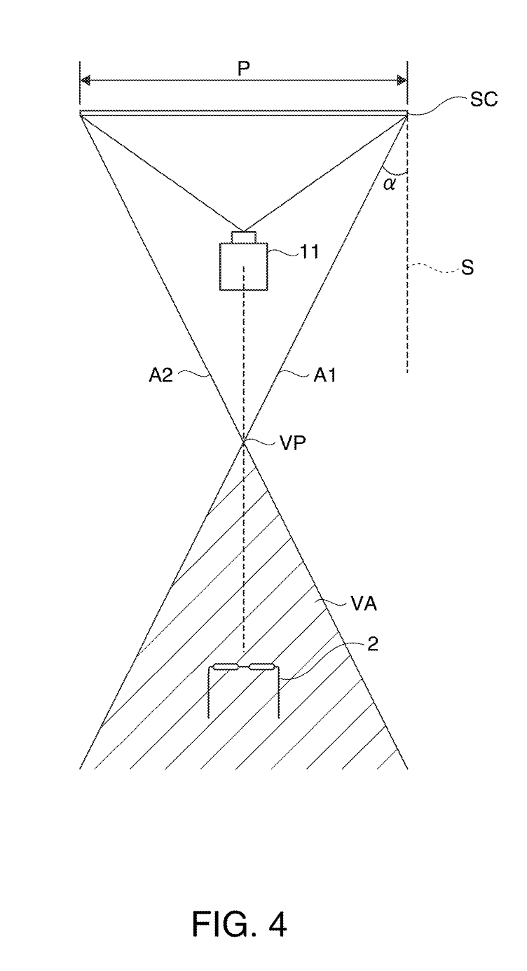

FIG. 4 is an explanatory view of a method for deriving a range of viewing position by the viewing position deriving section 144, showing a overhead plan view of a viewing space in which the screen SC and the projector 11 are installed. In FIG. 4, the reference sign P shows a projection range of an image on the screen SC, and a shows a view angle. A range VA shown with hatchings is a range of viewing position obtained by the viewing position deriving section 144. FIG. 4 illustrates a configuration in which the projector 11 performs projection from the front side of the screen SC. However, it is of course applicable to the case where the projector 11 performs projection from the rear side of the screen SC.

The view angle α shown in the drawing is a view angle in the horizontal direction with respect to the screen SC. At the lateral ends of the projection range P, lines A1 and A2 with the same angle as the view angle α are drawn with respect to the screen SC, and an intersection point of the lines A1 and A2 is defined as VP. The range VA located at a position farther away from the screen SC than the intersection point VP is and surrounded by the lines A1 and A2 is determined as the range of viewing position suitable for stereoscopic vision. Since the range VA is located behind the intersection point VP, the entire projection range P can be viewed well. Moreover, at the position surrounded by the lines A1 and A2, both a left-eye image and a right-eye image can be visually recognized clearly. Further, when both the distance from the screen SC and the view angle are matched to the condition shown in the figure, a difference in vision between a left-eye image and a right-eye image is small. Thus, favorable stereoscopic vision is possible from any position as long as the position is in the range VA.

The viewing position deriving section 144 may obtain one or a plurality of viewing positions as pinpoints, not as a range like the range VA shown in FIG. 4.

The stereoscopic device position deriving section 145 as a position detecting unit shown in FIG. 3 acquires, from the wireless communication section 47 which transmits and receives a wireless signal to and from the stereoscopic device 2, the receiving intensity of the wireless signal transmitted from the stereoscopic device 2 or the delay time of transmission and reception of the signal. Then, the stereoscopic device position deriving section 145 performs a process for obtaining the position of the stereoscopic device 2 by, for example, a trilateration method based on the acquired intensity or delay time (arrival time of radio wave). As described above, when the projector 11 includes a plurality of wireless communication sections 47 or the wireless communication section 47 includes a plurality of antennas, and when the position of each of the wireless communication sections 47 or each of the antennas is specified, the position of the stereoscopic device 2 can be more precisely obtained.

When a plurality of stereoscopic devices 2 are present in a range which the wireless communication section 47 is capable of communication, the wireless communication section 47 performs communication with each of the stereoscopic devices 2 individually. In this case, the wireless communication section 47 obtains the receiving intensity or delay time of a wireless signal for each of IDs of the stereoscopic devices 2 and outputs the receiving intensity or delay time to the control section 103. The stereoscopic device position deriving section 145 of the control section 103 specifies the position of each of the stereoscopic devices 2 based on the receiving intensity or delay time for each ID. The position specified in this case may be a relative position on the basis of the projector 11 or another thing.

The in-view-area determining section 146 as a viewer position determining unit compares the position of the stereoscopic device 2 obtained by the stereoscopic device position deriving section 145 with the range of viewing position obtained by the viewing position deriving section 144 to determine whether or not the stereoscopic device 2 is located at a position deviated from the range of viewing position.

The guide image generating section 147 generates a guide image for simply showing a viewer the viewing position obtained by the viewing position deriving section 144. The guide image is an image showing by means of a design, for example, a positional relation between the position of the screen SC and a preferable viewing position and projected by the display control section 107 onto the screen SC. With this configuration, the viewer can precisely know at which position the viewer should be in viewing a stereoscopic image.

Moreover, if the in-view-area determining section 146 determines that the stereoscopic device 2 is located at a position deviated from the range of viewing position, the guide image generating section 147 generates a guide image including the position of the stereoscopic device 2.

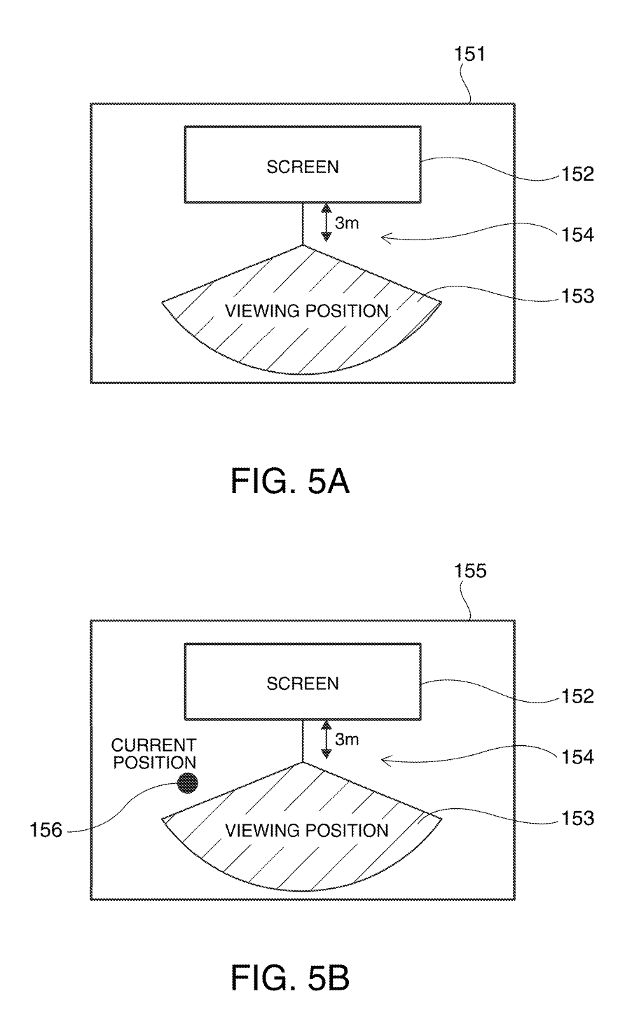

FIGS. 5A and 5B each show an example of a guide image which is generated by the guide image generating section 147 and displayed by the display control section 107. FIG. 5A shows an example of a guide image displayed when the stereoscopic device 2 is located within the range of viewing position, while FIG. 5B shows an example of a guide image displayed when the stereoscopic device 2 is located outside the range of viewing position.

The guide image 151 shown in FIG. 5A includes an image 152 showing the screen SC, an image 153 showing the range of viewing position, and a distance guide display 154 showing a distance from the screen SC to the range of viewing position. The guide image 151 is so displayed that a viewer can easily grasp a positional relation between the screen SC and the range of viewing position, and the shape of the range of viewing position. Moreover, the guide image 151 is so displayed that the viewer can easily understand that the range of viewing position having a fan shape is 3 m apart from the screen SC in the shortest distance. By displaying the guide image 151, the viewer can know the range of viewing position and easily determine from which position the viewer should view a stereoscopic image.

If the in-view-area determining section 146 determines that the stereoscopic device 2 is located at a position outside the range of viewing position, the guide image 155 shown in FIG. 5B is displayed. The guide image 155 includes, in addition to the images 152 and 153 and the distance guide display 154, a position display image 156 showing the position of the stereoscopic device 2 which is outside the range of viewing position. By displaying the position display image, a viewer wearing the corresponding stereoscopic device 2 can know that the viewer him/herself is outside the range of viewing position and to which position the viewer should move. In the guide image 155, a message or the like informing the viewer that the viewer is outside a preferable range of viewing position may be displayed.

Since a viewer viewing the guide images 151 and 155 has already worn the stereoscopic device 2, the guide images 151 and 155 may be displayed by means of a parallax image. However, by displaying as a planar image, such an advantage is provided that a viewer located at a position outside the range of viewing position can also visually recognize favorably.

As described above, since the viewing position deriving section 144 of the embodiment obtains the range of viewing position suitable for viewing a stereoscopic image, a viewing position is displayed as a range as shown in the images 152 and 153 in FIGS. 5A and 5B. However, the invention is not limited to this. For example, when the viewing position deriving section 144 obtains one or a plurality of points most suitable for viewing a stereoscopic image, dots or symbols representing the points may be displayed instead of the images 152 and 153 in the guide images 151 and 155.

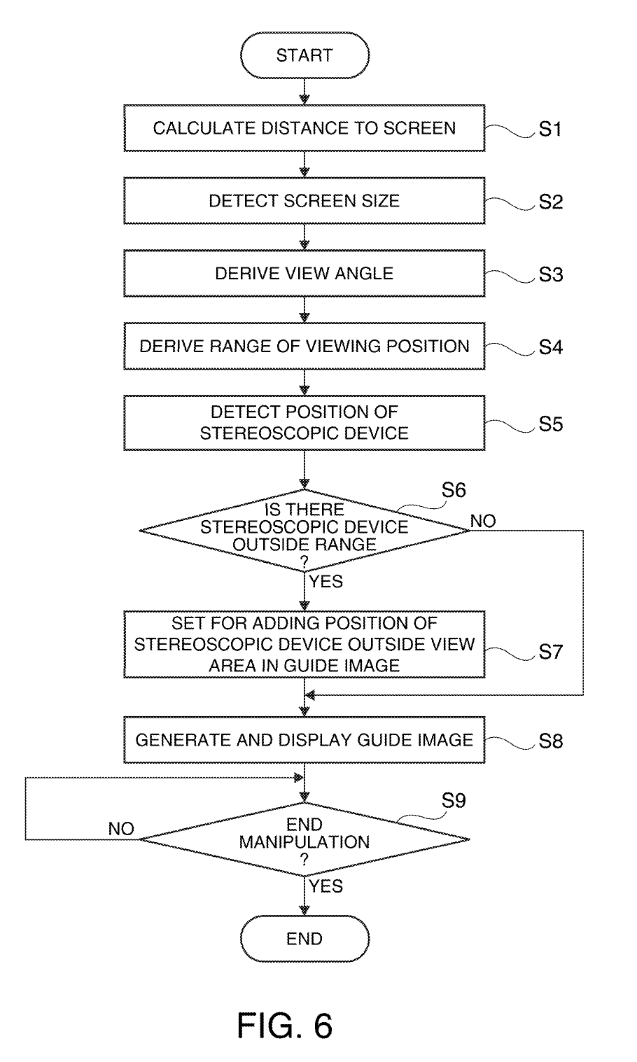

FIG. 6 is a flowchart showing operation of the projector 11, showing operation of displaying a guide image. In execution of the process shown in FIG. 6, the control section 103 functions as a display control unit together with the display control section 107.

When the control section 103 detects a manipulation of the remote control (not illustrated) with the remote control light-receiving section 41, or when the manipulation panel 45 detects a manipulation, the control section 103 initiates the operation of FIG. 6 in response to the manipulation. The control section 103 calculates, with the function of the screen position detecting section 141, a projection distance to the screen SC based on the zoom rate or adjusted value of focus of the projection optical system 33 (Step S1) and detects, with the function of the screen size detecting section 142, the size of a projection image on the screen SC based on the projection distance obtained by the screen position detecting section 141 and captured image data captured by the imaging section 5 (Step S2). Moreover, the control section 103 obtains a view angle with the function of the view angle deriving section 143 (Step S3) and obtains the range of viewing position which can provide stereoscopic vision with the function of the viewing position deriving section 144 (Step S4).

In this case, the control section 103 detects, with the function of the stereoscopic device position deriving section 145, one or a plurality of stereoscopic devices 2 located in a range which the wireless communication section 47 is capable of communication and specifies the position of each of the stereoscopic devices 2 (Step S5).

Thereafter, the control section 103 determines whether or not there is the stereoscopic device 2 located outside the range of viewing position (Step S6). If the corresponding stereoscopic device 2 is present (Yes in Step S6), the control section 103 makes settings for adding display showing the position of the stereoscopic device 2 to a guide image to be displayed on the screen SC (Step S7), generates the guide image according to the settings, and projects the guide image onto the screen SC with the projection section 3 (Step S8). On the other hand, if the stereoscopic device 2 located outside the range of viewing position is not present (No in Step S6), the control section 103 generates a guide image and projects the guide image onto the screen SC with the projection section 3 (Step S8).

After displaying the guide image, the control section 103 stands ready until being instructed through a manipulation of the remote control (not illustrated) or the manipulation panel 45 to end the display of the guide image (Step S9) and ends the process when a manipulation to instruct to end the display is performed (Yes in Step S9).

As described above, according to the display system 10 according to the embodiment to which the invention is applied, the projection section 3 displays a parallax image including a left-eye image and a right-eye image on the screen SC, and the control section 103 obtains, with the viewing position deriving section 144, a viewing position suitable for stereoscopic vision on the basis of the screen SC and displays the guide images 151 and 155 for showing the obtained viewing position on the screen SC. With this configuration, it is possible to reliably inform a viewer wearing the stereoscopic device 2 of the position suitable for viewing, and therefore, the viewer can properly determine from which position the viewer should view.

Moreover, since the viewing position deriving section 144 obtains the viewing position suitable for stereoscopic vision based on the projection size of a parallax image on the screen SC and the view angle of the screen SC, the viewing position suitable for viewing a stereoscopic image can be precisely derived according to the specification or state of the screen SC, and therefore, the position can be precisely shown to the viewer. The viewing position deriving section 144 may obtain the viewing position based on one of the projection size and the view angle.

The control section 103 controls the display control section 107 to project, onto the screen SC, the guide images 151 and 155 each of which is an image in which a relative position between the viewing position obtained by the viewing position deriving section 144 and the screen SC is designed. With this configuration, since the viewing position suitable for stereoscopic vision is shown to a viewer in such a manner that can be easily understood intuitively, the viewer can easily determine from which position the viewer should view. For example, when the viewing position is displayed as a range as shown in FIGS. 5A and 5B of the embodiment, it is possible to more intuitively and simply show the viewer from which position the viewer should view.

The projector 11 detects the position of a viewer with the stereoscopic device position deriving section 145, determines, with the in-view-area determining section 146, whether or not the detected position of the viewer corresponds to the viewing position obtained by the viewing position deriving section 144, and reflects the determined result on display of the screen SC. Therefore, display on which whether or not the position of the viewer deviates from a preferable viewing position is reflected is performed. With this configuration, it is possible to show whether or not the current position of the viewer is a position suitable for viewing a stereoscopic image. For example, when the viewing position suitable for stereoscopic vision is obtained as a range like the embodiment, it is possible, by clearly showing whether or not the viewer is within the range, to accurately introduce the viewer to the viewing position suitable for stereoscopic vision irrespective of the size or shape of the obtained range. Moreover, for example, when the viewing position suitable for stereoscopic vision is obtained as a specific point, it is possible, by showing the determined result, to precisely introduce the viewer to a limited position.

When the stereoscopic device 2 having the left-eye shutter 21 which transmits only a left-eye image of a parallax image displayed on the screen SC and the right-eye shutter 22 which transmits only a right-eye image is used, the stereoscopic device position deriving section 145 detects the position of the stereoscopic device 2. Therefore, when the parallax image is viewed with the stereoscopic device 2, it is possible to prevent a feeling of discomfort or the like due to an improper viewing position.

Moreover, the invention is applied to the projector 11 including, as the projection section 3, the illumination optical system 31, the liquid crystal panel 32 which modulates light emitted by the illumination optical system 31, and the projection optical system 33 which projects light modulated by the liquid crystal panel 32 onto the screen SC, and the screen size detecting section 142 which detects the size of a parallax image projected onto the screen SC is included. Thus, a proper viewing position when viewing a stereoscopic image by using the projector 11 can be shown to a viewer. The projector 11 has characteristics such that it can provide a very large projection image size, which the other display devices do not have. Even when it is hard for a viewer, because of the characteristics, to determine a proper viewing position by him/herself, it is possible, by applying the invention, to inform the viewer of the position suitable for viewing. Thus, the viewer can properly determine from which position the viewer should view.

The embodiment described above does not limit the invention, and the invention is also applicable as an aspect different from the embodiment. For example, the embodiment has been described by taking as an example a configuration in which the liquid crystal panel 32 which is composed of three transmissive or reflective liquid crystal panels corresponding to respective RGB colors is used as a light modulator which modulates light emitted by a light source in the projection section 3. However, the invention is not limited to this. For example, the invention may be configured by a method of combining one liquid crystal panel with a color wheel, a method of using three digital mirror devices (DMDs), a method of combining one digital mirror device with a color wheel, or the like. In this case, when only one liquid crystal panel or DMD is used as a light modulator, a member corresponding to a combining optical system such as a cross dichroic prism is not needed. Moreover, other than a liquid crystal panel and a DMD, any configuration can be adopted with no problem as long as it can modulate light emitted from a light source.

The display device of the invention is not limited to a projector which projects an image onto the screen SC. Also various kinds of display devices, such as a liquid crystal monitor or liquid crystal television which displays an image/image on a liquid crystal display panel, or a self-emitting display device such as a monitor device or television receiver which displays an image/image on a PDP (Plasma Display Panel) or a monitor device or television receiver which displays an image/image on an organic EL display panel called an OLED (Organic Light-Emitting Diode) or OEL (Organic Electro-Luminescence), are included in an image display device of the invention. In this case, a liquid crystal display panel, a plasma display panel, and an organic EL display panel each correspond to a display unit.

Further, in the embodiment, a configuration has been described in which the projector 11 obtains a projection image size on the screen SC based on captured image data of the imaging section 5 and a projection distance to the screen SC, obtains a viewing position suitable for viewing stereoscopic vision, and displays the guide images 151 and 155 on the screen SC. However, the invention is not limited to this. A configuration may be adopted in which a process for obtaining a viewing position suitable for viewing stereoscopic vision and a process for generating an guide image are executed by an external device, such as a personal computer, which is connected to the projector 11 via the I/F section 101. In this case, the imaging section 5 may be configured as an external device of the projector 11. Moreover, the function of detecting the position of the stereoscopic device 2 may be executed by the external device, such as a personal computer. In this case, a device which detects the position of the stereoscopic device 2 may be installed as an independent device in a viewing space in which the screen SC is installed, and information representing the position of the stereoscopic device 2 may be output from the device to the projector 11.

In the embodiment, the projection section 3 of the projector 11 displays a parallax image and a guide image. However, the invention is not limited to this. A parallax image and a guide image can be displayed by separate display devices. For example, the projection section 3 of the projector 11 may display a parallax image, and a display device other than the projector 11 may display a guide image.

The control programs 105A stored by the storage section 105 in the embodiment may be executed by downloading from another device to which the projector 11 is connected via a communication network. Alternatively, a configuration may be adopted in which the control programs 105A are recorded on a portable recording medium and each of the programs is executed by reading from the recording medium.

Each of the functional sections of the stereoscopic device 2 and the projector 11 shown in FIGS. 2 and 3 shows a functional configuration, and a specific mounting form is not particularly limited. That is, it is not always necessary that hardware individually corresponding to each of the functional sections be mounted, and it is of course possible to adopt a configuration in which one processor executes programs to thereby realize the functions of a plurality of functional sections. Moreover, a part of the functions realized by software in the embodiment may be realized by hardware, or a part of the functions realized by hardware may be realized by software. In addition, a specific detailed configuration of the display system 10 can be optionally modified in a range not departing from the gist of the invention.

What is claimed is:

1. A display device comprising:
a display unit which displays a parallax image on a display surface;
a viewing position deriving unit which obtains a viewing position suitable for stereoscopic vision on the basis of the display surface; and
a display control unit which causes the display unit to perform display for showing the viewing position obtained by the viewing position deriving unit.

2. The display device according to claim 1, wherein
the viewing position deriving unit obtains a viewing position suitable for stereoscopic vision based on at least one of a display size of the parallax image on the display surface and a view angle of the display surface.

3. The display device according to claim 1, wherein
the display control unit causes the display unit to display an image showing a relative position between the viewing position obtained by the viewing position deriving unit and the display surface.

4. The display device according to claim 1, further comprising
a position detecting unit which detects a position of a viewer, and
a viewer position determining unit which determines whether or not the position of the viewer detected by the position detecting unit corresponds to the viewing position obtained by the viewing position deriving unit, wherein
the display control unit reflects a result determined by the viewer position determining unit on display of the display unit.

5. The display device according to claim 4, wherein
the position detecting unit detects, when a stereoscopic device having a left-eye transmitting portion which transmits only a left-eye image of the parallax image displayed on the display surface and a right-eye transmitting portion which transmits only a right-eye image is used, a position of the stereoscopic device.

6. The display device according to claim 1, which is configured as a projector including, as the display unit, a light source, a modulation unit which modulates light emitted by the light source, and a projection unit which projects light modulated by the modulation unit onto a projection surface as the display surface, wherein
the display device further includes a projection size detecting unit which detects a size of a parallax image projected onto the projection surface.

7. A display system comprising:
a display device including a display unit which displays a parallax image; and
a stereoscopic device for observing the parallax image, wherein
the display device further includes
a viewing position deriving unit which obtains a viewing position suitable for stereoscopic vision through the stereoscopic device on the basis of the display surface, and
a display control unit which causes the display unit to perform display for showing the viewing position obtained by the viewing position deriving unit.

8. The display system according to claim 7, wherein
the viewing position deriving unit obtains a viewing position suitable for stereoscopic vision based on at least one of a display size of the parallax image on the display surface and a view angle of the display surface.

9. The display system according to claim 7, wherein
the display control unit causes the display unit to display an image showing a relative position between the viewing position obtained by the viewing position deriving unit and the display surface.

10. The display system according to claim 7, further comprising
a position detecting unit which detects a position of a viewer, and
a viewer position determining unit which determines whether or not the position of the viewer detected by the position detecting unit corresponds to the viewing position obtained by the viewing position deriving unit, wherein
the display control unit reflects a result determined by the viewer position determining unit on display of the display unit.

11. The display system according to claim 10, wherein
the stereoscopic device having a left-eye transmitting portion which transmits only a left-eye image of the parallax image displayed on the display surface and a right-eye transmitting portion which transmits only a right-eye image is used, and
the position detecting unit detects a position of the stereoscopic device.

12. The display system according to claim 7, which is configured as a projector including, as the display unit, a light source, a modulation unit which modulates light emitted by the light source, and a projection unit which projects light modulated by the modulation unit onto a projection surface as the display surface, wherein
the display system further includes a projection size detecting unit which detects a size of a parallax image projected onto the projection surface.

13. A method for controlling a display device, comprising:
displaying a parallax image on a display surface;
obtaining a viewing position suitable for stereoscopic vision on the basis of the display surface; and
performing display for showing the obtained viewing position.

14. The method for controlling the display device according to claim 13, wherein
obtaining the viewing position suitable for stereoscopic vision based on at least one of a display size of the parallax image on the display surface and a view angle of the display surface.

15. The method for controlling the display device according to claim 13, wherein
displaying an image showing a relative position between the viewing position obtained by the viewing position deriving unit and the display surface.

16. The method for controlling the display device according to claim 13, wherein
detecting a position of a viewer, and
determining whether or not the position of the viewer corresponds to the viewing position, and
reflecting the determined result on display of the display device.

17. The method for controlling the display device according to claim 16, wherein
detecting a position of a stereoscopic device having a left-eye transmitting portion which transmits only a left-eye image of the parallax image displayed on the display surface and a right-eye transmitting portion which transmits only a right-eye image is used.
